(19) United States
(12) Patent Application Publication
(10) Pub. No.: US 2020/0118160 A1
(43) Pub. Date: Apr. 16, 2020

(54) SYSTEMS, METHODS AND ARTICLES FOR BUY-SIDE OPTIMIZATION OF CONTENT PLACEMENT IN LINEAR MEDIACASTS

(71) Applicant: WideOrbit Inc., San Francisco, CA (US)

(72) Inventors: Ian P. Ferreira, Issaquah, WA (US); Kostyantyn Yanin, Sammamish, WA (US); Sai-Ming Li, Issaquah, WA (US)

(21) Appl. No.: 16/156,869

(22) Filed: Oct. 10, 2018

(51) Int. Cl. G06Q 30/02

(52) U.S. Cl. CPC G06Q 30/0244; G06Q 30/0276

(57) ABSTRACT

Systems, methods and articles for automating and optimizing the purchase of spots in mediacasts to allow goals to be met or exceeded in ways that were previously difficult or impossible. An autonomous purchase system is provided where buyers can automatically receive offers for placement opportunities simultaneously via a single interface, and the system can optimize selection of the received offers based on various optimization criteria that may be specified by the advertiser. The optimized selection may be presented using a heat map that allows the user to quickly identify the value of a plurality of offers.

### BACKGROUND

### Technical Field

The present disclosure relates the field of computer technology, and more particularly, to computer systems and methods that facilitate the delivery of content to consumers.

### Description of the Related Art

Content providers such as radio stations and networks, television stations and networks, and Webcasters provide programming including content which is the subject of programming. Content providers' delivery of content is often via broadcasts or Webcasts (collectively, “mediacasts”). While content providers may employ repeaters and the like, broadcasts are typically limited in range to a geographic region.

Programming often includes advertisements interspersed with the subject matter of the programming. The advertisements may occur in segments or slots sometimes referred to as “ad breaks.” Content providers typically sell advertising time to generate revenue to fund operation, as well as generate profits, where the content provider is a commercial entity rather than a nonprofit entity. Given that most broadcasts are local in nature or extent, content providers often carry advertisements and other material which is of a somewhat local or parochial interest. For example, a local chain may place advertisements with a local broadcaster since the audience targeted by the local chain is also often local and local advertising tends to be less expensive than regional or national advertising.

New approaches that automate the various activities related to buying, selling and placement of new materials, for instance, advertisements, in mediacasts are desirable.

### BRIEF SUMMARY

A method of optimizing advertisement placement in linear mediacasts may be summarized as including: storing, in at least one nontransitory processor-readable storage medium, a plurality of offers for advertisement placement opportunities for an advertiser, each of the plurality of offers for advertisement placement opportunities comprising an offer for the advertiser to place one or more advertisements in at least one of a number of linear mediacasts for each of a plurality of mediacast content providers that transmit the linear mediacasts to a plurality of media consumers over a period of time; receiving, by at least one processor, optimization criteria from the advertiser; optimizing, by the at least one processor, a selection of a subset of the plurality of offers for advertisement placement opportunities based at least in part on the received optimization criteria; and presenting, by the at least one processor, the selected subset of the plurality of offers for advertisement placement opportunities to the advertiser via an advertiser-facing user interface.

The method of optimizing advertisement placement in linear mediacasts may further include sending, by the at least one processor, orders for the purchase of advertisement opportunities to the mediacast content providers based on the selected subset of the plurality of offers for advertisement placement opportunities.

The method of optimizing advertisement placement in linear mediacasts may further include, subsequent to the sending of the orders, re-optimizing a selection of a plurality of offers for advertisement placement opportunities based on optimization criteria and based on information relating to the sent orders.

The method of optimizing advertisement placement in linear mediacasts may further include, prior to re-optimizing, receiving, by the at least one processor, updated optimization criteria from the advertiser.

The information regarding the sent orders may include information relating to at least one of the respective prices of at least some of the sent orders, the performance of at least some of the sent orders, or targeting criteria for at least some of the sent orders.

The method of optimizing advertisement placement in linear mediacasts may further include receiving, by the at least one processor, a spending budget from the advertiser, wherein receiving the optimization criteria may include receiving an indication that the advertiser requests to maximize advertising impact, and optimizing a selection of a subset of the plurality of offers may include determining a subset of the offers to select that maximizes the advertising impact without exceeding the received spending budget.

The method of optimizing advertisement placement in linear mediacasts may further include receiving, by the at least one processor, an advertising impact target and a spending budget from the advertiser, wherein receiving the optimization criteria may include receiving an indication that the advertiser requests to minimize the spending budget, and optimizing a selection of a subset of the plurality of offers may include determining a subset of the offers to select that minimizes the spend while meeting the advertising impact target.

The method of optimizing advertisement placement in linear mediacasts may further include receiving, by the at least one processor, a spending budget from the advertiser, wherein receiving the optimization criteria may include receiving an indication that the advertiser requests to maximize gross ratings points (GRPs), and optimizing a selection of a subset of the plurality of offers may include determining a subset of the offers to select that maximizes the GRPs without exceeding the received spending budget.

The method of optimizing advertisement placement in linear mediacasts may further include receiving, by the at least one processor, a gross ratings points (GRPs) target and a spending budget from the advertiser, wherein receiving the optimization criteria may include receiving an indication that the advertiser requests to minimize the spending budget, and optimizing a selection of a subset of the plurality of offers may include determining a subset of the offers to select that minimizes the spending amount while meeting the GRPs target.

The selected subset of the plurality of offers may include a first subset, the method further including: receiving, by the at least one processor via the advertiser-facing user interface, a modification of the first subset of the plurality of offers for advertisement placement opportunities; re-optimizing, by the at least one processor, a selection of a second subset of the plurality of offers for advertisement placement opportunities based at least in part on the received optimization criteria and the received modification of the first subset of the plurality of offers for advertisement placement opportunities; and presenting, by the at least one processor, the second subset of the plurality of offers for advertisement placement opportunities to the advertiser via an advertiser-facing user interface. Receiving a modification of the first subset of the plurality of offers may include at least one of: manual selection of an offer that is not in the first subset of the plurality of offers, or manual de-selection of an offer that is in the first subset of the plurality of offers. Receiving a modification of the first subset of the plurality of offers may include receiving filtering criteria that excludes one or more of the plurality of offers from consideration. Receiving filtering criteria may include receiving filtering criteria that relates to at least one of: programming content category, programming content rating, programming content daypart, or programming content target demographics. The optimization criteria may include repetition criteria relating to at least one of: a maximum number of advertisement opportunities to be selected for a single transmission of any one program; or a maximum number of advertisement opportunities to be selected during a multi-day time period for any one program.

The method of optimizing advertisement placement in linear mediacasts may further include receiving, by the at least one processor, the repetition criteria from the advertiser.

The method of optimizing advertisement placement in linear mediacasts may further include receiving, by the at least one processor, the repetition criteria from a media content provider that is offering one or more of the advertisement opportunities.

The optimization criteria may include smoothing criteria that specifies at least one of: a maximum percentage of a specified budget that is allowed to be spent for any one program; or a maximum percentage of a specified budget that is allowed to be spent for any one channel.

The method of optimizing advertisement placement in linear mediacasts may further include receiving, by the at least one processor, a gross ratings points (GRPs) target and a spending budget from the advertiser, wherein receiving the optimization criteria comprises receiving an indication that the advertiser requests to optimize the selection of offers with respect to both the GRPs target and the spending budget, and optimizing a selection of a subset of the plurality of offers comprises determining a subset of the offers that meet both the spending budget and the GRPs target.

Optimizing a selection of a subset of the plurality of offers may take into account one or more advertiser goals or criteria relating to one or more of: target demographics goals, daypart goals, affiliate goals, market level goals, spot length goals, weekly goals, or excluded programs. Optimizing a selection of a subset of the plurality of offers may take into account one or more advertiser priorities relating to a spot length priority or a daypart priority. Presenting the selected subset of the plurality of offers may include presenting the selected subset of the plurality of offers for advertisement placement opportunities on a heat map that is color-coded with respect to at least one of cost per point (CPP) or the number of selected offers for a particular program.

The method of optimizing advertisement placement in linear mediacasts may further include: receiving, by the at least one processor, requests for available advertisement placement opportunities from the advertiser; sending, by the at least one processor, the received requests for available advertisement placement opportunities to the plurality of mediacast content providers; and receiving, by the at least one processor, the plurality of offers for advertisement placement opportunities from the plurality of mediacast content providers.

A system to optimize advertisement placement in linear mediacasts may be summarized as including: at least one nontransitory processor-readable storage medium that stores at least one of instructions or data, and which stores a plurality of offers for advertisement placement opportunities for an advertiser, each of the plurality of offers for advertisement placement opportunities comprising an offer for the advertiser to place one or more advertisements in at least one of a number of linear mediacasts for each of a plurality of mediacast content providers that transmit the linear mediacasts to a plurality of media consumers over a period of time; and at least one processor communicatively coupled to the at least one nontransitory processor-readable storage medium, in operation, the at least one processor: receives optimization criteria from the advertiser; optimizes a selection of a subset of the plurality of offers for advertisement placement opportunities based at least in part on the received optimization criteria; and presents the selected subset of the plurality of offers for advertisement placement opportunities to the advertiser via an advertiser-facing user interface.

The at least one processor may send orders for the purchase of advertisement opportunities to the mediacast content providers based on the selected subset of the plurality of offers for advertisement placement opportunities. The at least one processor may, subsequent to sending of the orders, re-optimize a selection of a plurality of offers for advertisement placement opportunities based on optimization criteria and based on information relating to the sent orders. The at least one processor may, prior to the re-optimization, receive updated optimization criteria from the advertiser. The information regarding the sent orders may include information relating to at least one of the respective prices of at least some of the sent orders, the performance of at least some of the sent orders, or targeting criteria for at least some of the sent orders. The at least one processor may receive a spending budget from the advertiser, wherein the optimization criteria may include an indication that the advertiser requests to maximize advertising impact, and the at least one processor may determine a subset of the offers to select that maximizes the advertising impact without exceeding the received spending budget. The at least one processor may receive an advertising impact target and a spending budget from the advertiser, wherein the optimization criteria may include an indication that the advertiser requests to minimize the spending budget, and the at least one processor may determine a subset of the offers to select that minimizes the spend while meeting the advertising impact target. The at least one processor may receive a spending budget from the advertiser, wherein the optimization criteria may include an indication that the advertiser requests to maximize gross ratings points (GRPs), and the at least one processor may determine a subset of the offers to select that maximizes the GRPs without exceeding the received spending budget. The at least one processor may receive a gross ratings points (GRPs) target and a spending budget from the advertiser, wherein the optimization criteria may include an indication that the advertiser requests to minimize the spending budget, and the at least one processor may determine a subset of the offers to select that minimizes the spending amount while meeting the GRPs target. The selected subset of the plurality of offers may include a first subset, and the at least one processor may: receive, via the advertiser-facing user interface, a modification of the first subset of the plurality of offers for advertisement placement opportunities; re-optimize a selection of a second subset of the plurality of offers for advertisement placement opportunities based at least in part on the received optimization criteria and the received modification of the first subset of the plurality of offers for advertisement placement opportunities; and present the second subset of the plurality of offers for advertisement placement opportunities to the advertiser via the advertiser-facing user interface. The modification of the first subset of the plurality of offers may include at least one of: manual selection of an offer that is not in the first subset of the plurality of offers, or manual de-selection of an offer that is in the first subset of the plurality of offers. The modification of the first subset of the plurality of offers may include filtering criteria that excludes one or more of the plurality of offers from consideration. The filtering criteria may relate to at least one of: programming content category, programming content rating, programming content daypart, or programming content target demographics. The optimization criteria may include repetition criteria relating to at least one of: a maximum number of advertisement opportunities to be selected for a single transmission of any one program; or a maximum number of advertisement opportunities to be selected during a multi-day time period for any one program. The at least one processor may receive the repetition criteria from the advertiser. The at least one processor may receive the repetition criteria from a media content provider that is offering one or more of the advertisement opportunities. The optimization criteria may include smoothing criteria that specifies at least one of: a maximum percentage of a specified budget that is allowed to be spent for any one program; or a maximum percentage of a specified budget that is allowed to be spent for any one channel. The at least one processor may receive a gross ratings points (GRPs) target and a spending budget from the advertiser, wherein the optimization criteria may include an indication that the advertiser requests to optimize the selection of offers with respect to both the GRPs target and the spending budget, and the at least one processor may determine a subset of the offers that meet both the spending budget and the GRPs target. The at least one processor may optimize a selection of a subset of the plurality of offers taking into account one or more advertiser goals or criteria relating to one or more of: target demographics goals, daypart goals, affiliate goals, market level goals, spot length goals, weekly goals, or excluded programs. The at least one processor may optimize a selection of a subset of the plurality of offers taking into account one or more advertiser priorities relating to a spot length priority or a daypart priority. The at least one processor may present the selected subset of the plurality of offers for advertisement placement opportunities on a heat map that is color-coded with respect to at least one of cost per point (CPP) or the number of selected offers for a particular program. The at least one processor may: receive requests for available advertisement placement opportunities from the advertiser; send the received requests for available advertisement placement opportunities to the plurality of mediacast content providers; and receive the plurality of offers for advertisement placement opportunities from the plurality of mediacast content providers.

A nontransitory processor-readable storage medium may be summarized as one that that stores at least one of instructions or data, and which stores a plurality of offers for advertisement placement opportunities for an advertiser, each of the plurality of offers for advertisement placement opportunities comprising an offer for the advertiser to place one or more advertisements in at least one of a number of linear mediacasts for each of a plurality of mediacast content providers that transmit the linear mediacasts to a plurality of media consumers over a period of time, the at least one nontransitory processor-readable storage medium, when executed by at least one processor of an audience delivery optimizer system, cause the at least one processor to: receive optimization criteria from the advertiser; optimize a selection of a subset of the plurality of offers for advertisement placement opportunities based at least in part on the received optimization criteria; and present the selected subset of the plurality of offers for advertisement placement opportunities to the advertiser via an advertiser-facing user interface.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram of a networked environment, including an automated advertisement purchase computer system communicatively coupled between sellers, such as terrestrial radio or television providers or Webcasters, and buyers, such as advertisers who have advertisements to place or who otherwise control placement of advertisements, according to one illustrated implementation.

FIG. 2 is a workflow diagram of portions of the networked environment of FIG. 1, showing an example workflow for a transaction utilizing the advertisement purchase computer system, according to one illustrated implementation.

FIG. 3 is a flow diagram showing a method of operating an automated advertisement purchase system to request and receive a plurality of offers for advertisement placement opportunities, according to one non-limiting illustrated implementation.

FIG. 4 is a flow diagram showing a method of operating an automated advertisement purchase system to optimize the selection and purchase of advertisement placement opportunities, according to one non-limiting illustrated implementation.

FIG. 5 is a flow diagram showing a method of operating an automated advertisement purchase system to modify and re-optimize a selection and purchase of advertisement placement opportunities, according to one non-limiting illustrated implementation.

FIG. 6 is a screenshot of an example campaign configuration user interface of an automated advertisement purchase system, according to one non-limiting illustrated implementation.

FIG. 7 is a screenshot of an example submit avail requests user interface of an automated advertisement purchase system, according to one non-limiting illustrated implementation.

FIG. 8 is a screenshot of an example campaign optimizer user interface of an automated advertisement purchase system, according to one non-limiting illustrated implementation.

FIGS. 9A-9E are a screenshot of an example dashboard or powersheet user interface of an automated advertisement purchase system, according to one non-limiting illustrated implementation.

FIG. 10 is a screenshot of an optimized plan user interface of an automated advertisement purchase system, according to one non-limiting illustrated implementation.

FIG. 11 is a screenshot of a filters user interface of an automated advertisement purchase system, according to one non-limiting illustrated implementation.

FIG. 12 is a flow diagram showing a method of operating an automated advertisement purchase system to modify and re-optimize a selection and purchase of advertisement placement opportunities after orders have been placed for a campaign, according to one non-limiting illustrated implementation.

FIG. 13 is a schematic diagram of an example computing environment in which one or more systems and methods of the present disclosure may be implemented, according to one non-limiting illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

One or more implementations of the present disclosure are directed to computer-implemented systems and methods of automating and optimizing the purchase of advertisements, or “spots,” to allow advertisers meet or exceed their goals in ways that were previously difficult or impossible. Buying television, radio and digital advertising has traditionally been a highly manual process and requires many participants to execute orders. Layering in audience and pricing data adds another level of complexity to the campaign execution workflow.

In conventional workflows, if an advertiser operates in 20 markets and wants to advertise locally in those markets, a representative of the advertiser must contact (e.g., call, email) multiple networks in each of the 20 markets to negotiate and purchase advertising. In this example, if the advertiser wants to inquire about or purchase advertising with 5 to 7 networks in each of the 20 markets, the advertiser would need to manually contact and negotiate with 100-150 networks, which is an extremely time consuming and inefficient process.

Implementations of the present disclosure are directed to computer-implemented systems and methods for providing an autonomous advertisement purchase system where buyers can automatically receive offers for advertisement placement opportunities simultaneously via a single interface, and the system can optimize selection of the received offers based on various optimization criteria that may be specified by the advertiser. Thus, the aforementioned manual and inefficient process is automated and provides optimization that was previously not possible using conventional workflows.

In at least some implementations, buyers and sellers can trade mediacast (e.g., broadcast, Webcast) advertisement inventory (e.g., direct or programmatically) at local, national, and/or worldwide levels. The types of media traded via may simultaneously include numerous types of media, including TV, cable, satellite, radio, outdoor, print, etc. Such programmatic advertising implements data-driven automation of audience-based advertising operations which inverts the industry standard in which marketers rely on show ratings to determine desirable audiences for the marketers' advertisements. Instead, with programmatic, marketers may use audience data to pipe advertising to optimal places. For example, marketers may use programmatic technology to reach a more specific set of consumers regardless of on which programs the advertisements appear.

In at least some implementations, the systems of the present disclosure seamlessly blend traditional linear media (e.g., TV, cable, satellite, radio, outdoor, print) sales practices with data-driven digital advertisement buying methods. In some implementations, the systems are fully automated seller-controlled advertisement purchase systems which connect local mediacasters (e.g., broadcasters, Webcasters, printed content providers) with new and existing demand sources and offer revenue management tools for optimizing yields across direct and programmatic channels. Transactions may be demand-led, which allows sellers to view the demand across the sellers' entire landscape of potentially available advertisement inventory. Further, in some implementations, the sellers may accept or reject bid responses from buyers without revealing price floors or available advertisement opportunities to any of the buyers.

In at least some implementations, the advertisement purchase systems disclosed herein interface with demand side platforms (DSPs) that make automated media advertisement purchases. Participating sellers enjoy seamless transaction workflow for getting advertisements from proposal, to publishing, and to billing that delivers a significant reduction in time spent on reconciliation and “make-goods” and streamlines processes for creative management and revenue management across direct and programmatic sales channels.

In some implementations, the advertisement purchase systems include powerful yield management tools that give participating sellers the power to retain full control of pricing floors and inventory allocation across direct and programmatic sales channels. The advertisement purchase systems may also honor all placement rules for delivery separation and automatic management of potential channel conflict across advertisements sold directly and through the advertisement purchase system.

The advertisement purchase systems may include a seller side platform (SSP) or console for sellers (e.g., broadcasters, Webcasters, printed content providers) and an advertiser-facing interface or console for demand side platform (DSP) entities to interface with the advertisement purchase systems. Through the SSP, sellers can access demand and make advertisement inventory available and accept or reject bid responses based on marketplace demand.

The advertiser-facing interface facilitates creative placement and reviewing for the buy side, and may have transcoding and approval tools for the sell side. For example, in some implementations, once an advertisement transaction is approved, the advertiser-facing interface sends the advertisement directly to a broadcaster's traffic system. In some implementations, the advertisement purchase system is a sell-side powered marketplace, which allows sellers to set price floors and to retain the right to accept or reject any offer which comes through the advertisement purchase system. In some implementations, the advertisement purchase systems disclosed herein automate aspects of billing, reconciliation, and creative execution. In some implementations, the advertisement purchase systems may be integrated with advertisement management software and sales and traffic management systems.

In one or more implementations disclosed herein, the systems do not require sellers to offer particular day parts or times when advertisement inventory is available. That is, “carve-outs” are not required. Rather, buyers can extend offers for the entire roster or landscape for a particular channel for a particular period of time (e.g., mediacast day). Thus, sellers may peruse this demand and decide which offers to accept or not to accept.

As discussed further below, in some implementations, the advertisement inventory is bought and sold as canonical inventory units which group similar but discrete advertisement slots together. For example, for linear media an inventory unit may be defined as a specific channel, day and time period (e.g., 30 minutes). In at least some implementations, when the marketplace opens for a given mediacast day, the marketplace may issue requests for bids (RFBs) for all inventory units for that mediacast day. Buyers may price the inventory units and provide a bid for any of the inventory units. At a daily market close, the advertisement purchase may notify the buyers of the win/loss outcomes. In some implementations, the demand (e.g., bid responses) may be expressed for future slots but sellers may accept near publishing time (e.g., 10 seconds before airtime, 10 minutes before airtime).

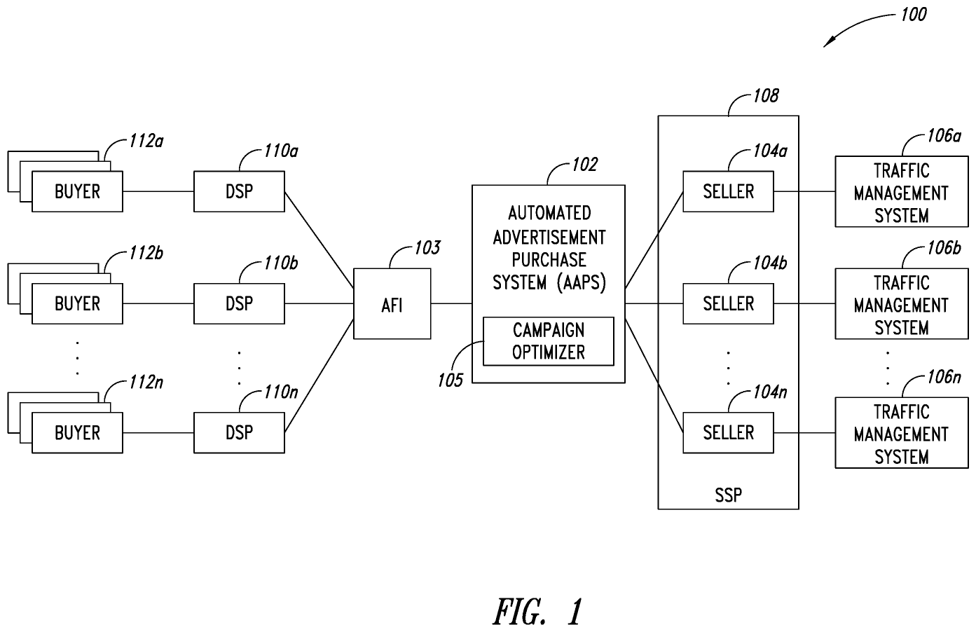

FIG. 1 shows an example networked environment 100 according to one illustrated implementation in which various apparatus, methods and articles described herein may operate. The environment 100 includes an advertisement purchase or exchange system 102 that includes a campaign optimizer module 105, discussed below, an advertiser-facing interface (AFI) 103, a number of sellers or content providers 104A-104N (collectively 104), traffic management systems 106A-106N (collectively 106), a supply side platform (SSP) 108, a number of demand side platforms (DSPs) 110A-110N (collectively 110), and a number of buyers 112A-112N (collectively 112), all communicatively coupled by one or more networks or other communications channels. The various components of the environment may be distributed or integrated in any number of ways. For example, in at least some implementations, two or more of the DSPs 110, AFI 103, automated advertisement purchase system 102, SSP 108 and traffic management system 106 may be integrated into a single platform provided by one or more entities.

The sellers 104 may take a variety of forms, for example, radio stations or broadcasters, television stations or broadcasters, other terrestrial or satellite broadcasters or multicasters (not shown), Webcasters, printed content (e.g., print media) providers, outdoor content (e.g., billboards) providers, etc. The sellers 104 may, or may not, own the content that they provide. The sellers 104 utilize the SSP 108 to access the advertisement purchase system 102 and may use the traffic management systems 106A-106N for traffic management. On the buy side, the buyers 112 (e.g., advertisers, agencies) may interface with the system 102 via the AFI 103 through the buyers' respective DSPs 110.

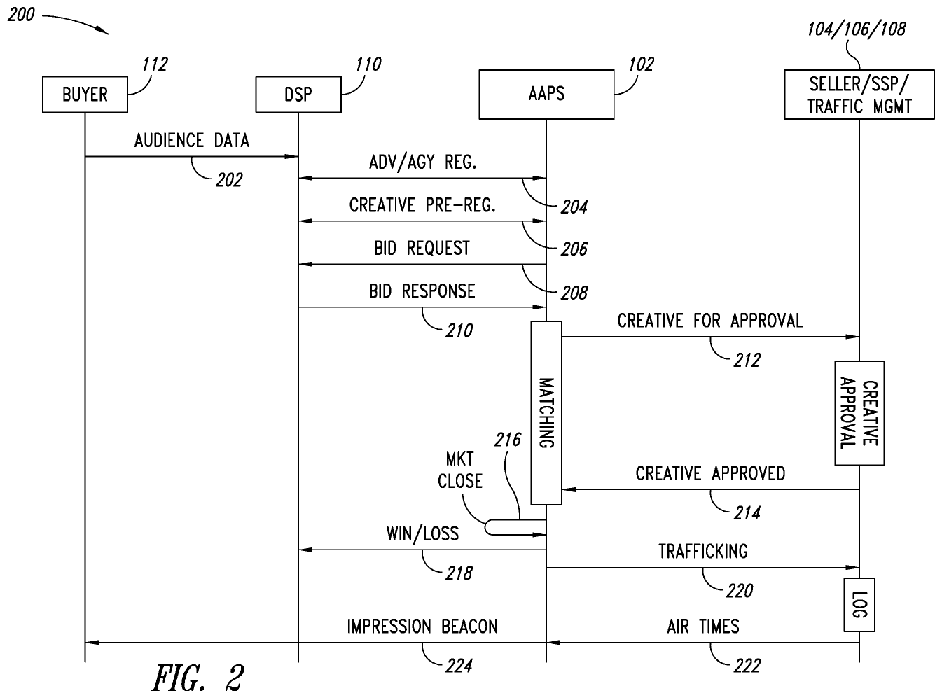

FIG. 2 shows a non-limiting example workflow 200 for implementing the advertisement purchase system 102 in the environment 100 of FIG. 1 between a buyer 112, a buyer's DSP 110, the advertisement purchase system 102, and a seller 104 interfacing with the advertisement purchase system 102 through the SSP 108 and the traffic management system 106. FIG. 2 depicts a workflow for programmatic purchasing of advertisements, although it should be appreciated that the features discussed herein may also be used in direct purchasing environments, as discussed in the examples provided below. Generally, the AFI 103 exposes future advertisement inventory (avails) to DSPs which can bid on the entire supply landscape and receive daily win/loss notifications for the inventory (e.g., for the following week).

At 202, the buyer 112 may enter advertising campaign constraints through the DSP 110. Such campaign constraints may include budget, target audience, channels, day parts, etc. The campaign constraints may be cross-media types (e.g., TV, cable, radio, satellite, outdoor, print). At 204, the buyer 112 may send an advertiser and/or agency name mapping to the advertisement purchase system 102 via the DSP 110 based on agencies and advertisers already existing in the advertisement purchase so that the buyer is associated with an advertiser and/or agency name in the marketplace. At 206, a creative agency associated with the buyer 112 may upload a creative (e.g., advertisement content) which will be used in campaigns through the DSP 110. The DSP 110 may provision the creative to the advertisement purchase 102, which may download, ingest and validate the creative, and may then send an identifier (e.g., “creative ID”) back to the DSP for use in a subsequent bid response.

At 208, the advertisement purchase system 102 may send a request for bids (RFBs) to the DSP 110 for every canonical inventor unit. As noted above, in some implementations, a canonical inventory unit is defined as a time period in a mediacast day for a particular channel and/or market (e.g., Channel X, Market Y, Nov. 3, 2015, 5:30-6:00 am). The advertisement purchase system 102 may send RFBs for all canonical inventory units in the marketplace for a particular period of time (e.g., day, week). In some implementations, each inventory unit in the advertisement purchase system has a unique channel, market, and time period combination. In some implementations, the advertisement purchase system 102 operates one week ahead of a publication date (e.g., airdate), but other future time windows may also be used.

At 210, the DSP 110 responds to the RFBs provided by the advertisement purchase system 102 with demand for one or more of the inventory units. The DSP 110 may apply targeting criteria prior to issuing bids. In some implementations, the DSP 110 does not need to notify the advertisement purchase system 102 of the targeting data source or attributes used to determine the bids or inventory unit selection.

At 212, the advertisement purchase system 102 validates received bids and begins matching bids with inventory supply. At 214, the SSP 108 pulls creative previews and alerts the seller 104 to possible bids to approve. The seller may approve the creatives and bids and may then send the approvals to the advertisement purchase system 102 for consideration.

At 216, the advertisement purchase system 102 closes the marketplace for the day. The winning spots are sent to the traffic management system 106 for publishing (e.g., airing, printing). At 218, the advertisement purchase system 102 may send a “win” beacon to the DSP 110, which allows the buyer 112 to decrement the buyer's budget through the DSP as needed.

At 220, the seller 104 may process orders through the traffic management system 106. At 222, the seller 104 may reconcile actual air times with the advertisement purchase system 102 through the traffic management system 106.

At 224, the advertisement purchase system 102 may send impression and completion event beacons to the buyer 112 through the DSP 110. Such beacons may be sent after the spot has aired (e.g., up to 30 days later).

In some implementations, before a DSP can win bids, creative should be sent to the advertisement purchase system 102 to be stored in a nontransitory processor-readable storage medium accessible thereby. As noted above, when a creative is submitted by a DSP to the advertisement purchase system 102 through the AFI 103, an identifier is sent back to the DSP. Then, advertisement purchase system 102 ingests the creative and validates that the creative assets meets the technical requirements necessary for the creative to be trafficked and aired successfully. In some implementations, creatives are pre-registered. In such cases, bid responses from DSPs designate a pre-registered creative identifier.

As noted above, for linear media a canonical inventory unit may be defined a specific channel, market, day, and time period (e.g., half hour, one hour). Each canonical inventory unit may include a plurality (e.g., 12-18) of discrete advertisement slots which have a duration that is shorter than the specified time period for the inventory unit. For example, the durations for the advertisement slots may be 15 seconds, 30 seconds, 45 seconds, 60 seconds, 90 seconds, etc., while the specified time period for the canonical inventory unit may be 15 minutes, 30 minutes, 2 hours, etc. The precise time or position of these slots in the corresponding specified time period may or may not be defined at the time of a bid or known by the bidder. Even the seller may not know the precise time or the precise order of the slots prior to publication (e.g., broadcast).

When the marketplace opens for a particular mediacast day, RFBs are issued for all canonical inventory units for the mediacast day. Buyers are able to price the inventory units individually to provide spot bids. At the daily close of the marketplace, the advertisement purchase system 102 notifies buyers 112 through respective DSPs 110 of the win/loss outcomes.

In cases of print media, a canonical inventory unit may be defined in a way such that similar but discrete advertisement slots are grouped together. For instance, for a daily newspaper, a canonical inventory unit may be defined by a section of the newspaper and by date (e.g., Sports section, May 3; Business section, May 6). In such instances, a seller may issue RFBs for all canonical inventory units in a future week of the newspaper.

The advertisement purchase system 102 may operate on a mediacast day schedule, which may vary between sellers (e.g., mediacast stations). Most commonly, mediacast day is from 5:00 AM to 4:59 XM (the next calendar day). The time period from 12:00 AM to 4:59 AM is represented as 12:00 AM to 4:59 XM, wherein the XM indicates that the time period is actually part of the next calendar day.

In some implementations, the advertisement purchase system 102 issues a unique RFB to the DSP 110 for every canonical inventory unit in the landscape (e.g., channels, markets) of the advertisement purchase system for a particular future time period (e.g., one upcoming mediacast day). Once the RFBs are sent to the DSP 110, the DSP may have an opportunity each day to submit a bid for each inventory unit. The availability of inventory may not be revealed to the buyers in these bid requests.

In some implementations, the advertisement purchase system 102 may perform a full landscape sweep on day X for inventory units containing spots which will air on the mediacast day one week later. For example, on a given Monday, the advertisement purchase system 102 may issue RFBs for all inventory units covering the mediacast day for the next Monday. This window may be more or less than one week in other implementations.

In some implementations, the advertisement purchase system 102 may allow DSPs to express demand (i.e., bids) for days beyond a single day one week ahead of the current day. For example, a DSP may wish to see RFBs on a rolling mediacast week basis. In such cases, the advertisement purchase system 102 may issue RFBs on a given Monday for all canonical inventory units for the next Monday through the next Sunday. Then, on Tuesday of the same week, the advertisement purchase system 102 may issue RFBs for all canonical inventory units for the next Tuesday through the next Monday, and so on. This configuration allows the DSP 110 to have more chances to bid on inventory units throughout the week, which can help fine tune bidding strategies and may facilitate campaign pacing.

Once all of the daily bids are collected, the advertisement purchase system 102 matches offers with inventory supply and generates orders that are integrated with the traffic management system 106. At this point, the bid status for each bid may be classified as Win, Loss, or Hold. The Win bid status indicates the offer has been accepted by seller for a specific canonical inventory unit. The Loss bid status indicates the offer was declined by seller, and may specify one or more loss reason codes. The Hold bid status indicates the offer has been accepted by the seller as part of a rotator. In some implementations, all bids in a rotator are set to the lowest bid rate in a particular grouping.

Given the nature of the advertisement purchase system 102 operations, budget management may be more complex than in a digital advertisement ecosystem. To facilitate budget management and to assist DSPs with expressing enough demand to meet their campaign objectives given the challenges introduced by the bid feedback latency, the advertisement purchase system 102 may utilize “bid group objects.” Each bid response can include a bid group object. A bid group object is a budget cap and/or a maximum spot wins constraint that can be assigned across multiple bids (and multiple media types) to avoid over-spending/over-winning during the feedback window. These budget caps and/or maximum spot wins may operate in a “first triggered” model, meaning that no more bids will be permitted to win after the budget cap or maximum spots cap are hit.

For example, the DSP 110 may group all bids for one campaign, for one day, into a bid group with a budget cap for the day. Then, the DSP 110 may issue bids for orders of magnitude more inventory and/or cost (e.g., $1,000,000) than the budget (e.g., $10,000) will support. The budget cap protects the buyer from winning all of the bids, which would exceed the budget. Thus, a buyer may issue bids as though the buyer has an “infinite budget” without the risk of exceeding the buyer's actual budget. Using such functionality, buyers can place bids in parallel without having to iteratively place bids, wait and see which bids are accepted, and place additional bids to fulfill their budget for a campaign. Such functionality also avoids the need for buyers to model acceptance rates to determine how much over the budget the buyer can safely bid without exceeding the budget. Depending on the accuracy of such model of acceptance rates and how aggressive a buyer is placing bids, there is the potential for the buyer to exceed the budget if the actual acceptance rate is higher than expected or for less than the budget to be spent if the actual acceptance rate is lower than expected. Such issues are avoided by use of the bid groups discussed above.

As another example, the DSP 100 may group all bids for a particular channel into a bid group object and set a maximum spot cap which limits the number of spots which will be purchased for the channel. Such feature may allow for “smoothing” a campaign across multiple channels and/or times without overly concentrating the buyer's budget on a particular market, affiliate, period of time, media outlet, geographical area, group of consumers, etc. As an example, a maximum spot cap may be established which limits the frequency which an advertisement is provided to the same group of consumers. The group of consumers may be determined statistically (e.g., by station times, programming) so that a particular advertisement is not provided to the same group of consumers more than N times over a time period.

In other implementations, the automated advertisement purchase system 102 may allow advertisers 112 to directly purchase advertisement slots from sellers 104 (e.g., cable networks) by sending requests for proposals to a plurality of sellers, providing a platform for negotiation with the sellers, automatically optimizing which proposals to accept, and allowing the advertisers to purchase inventory.

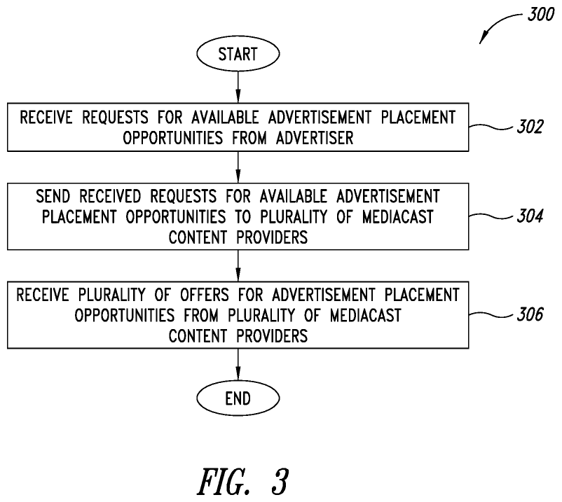

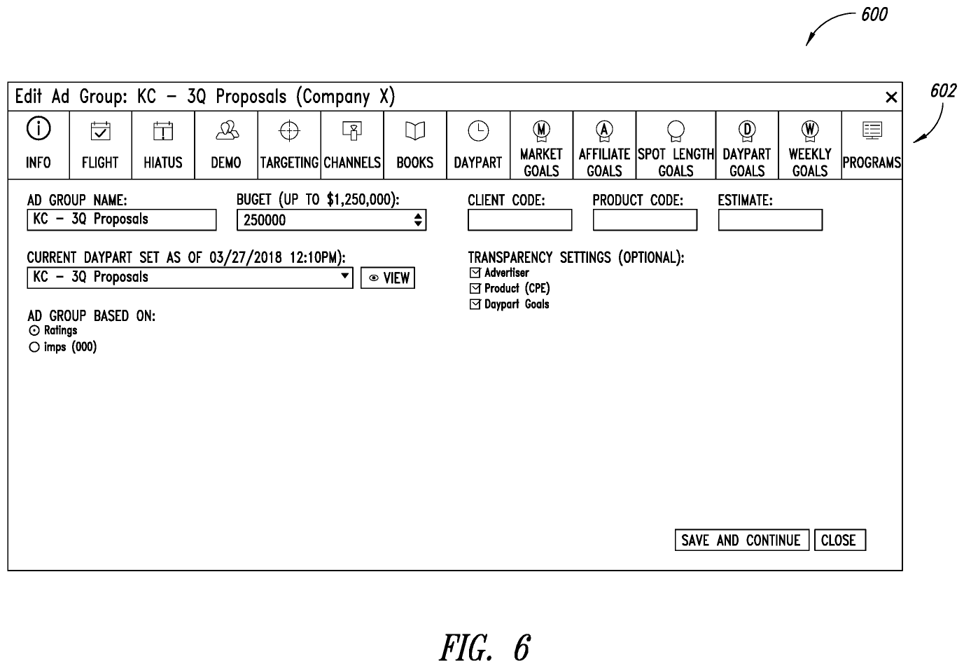

As shown in FIG. 3, the automated advertisement purchase system 102 may implement a method 300 that, at block 302, first receives requests for available advertisement placement opportunities from an advertiser. For example, a user interface 600 shown in FIG. 6 may be provided that allows the advertiser to select various configurations or goals 602 for a campaign. In the illustrated example shown in FIG. 6, the user interface 600 includes the following configurations or goals 602 that the advertiser can select: information, flight, hiatus, demo, targeting, channels, books, daypart, market goals, affiliate goals, spot length goals, daypart goals, weekly goals, and programs. These features allow the advertiser to select various criteria for the campaign. In other implementations, fewer or additional configurations or goals 602 may be provided for selection by the advertiser to define the particular features of a new campaign.

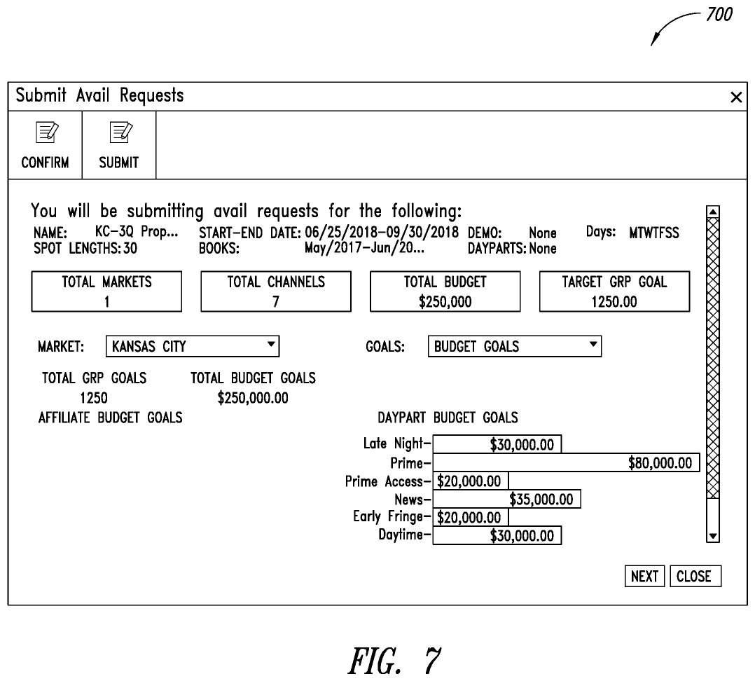

At 304, the automated advertisement purchase system 102 may send the received requests for available advertisement placement opportunities to a plurality (e.g., 10, 100, 200, 500) of mediacast content providers specified in the user interface 600. An example submit avail requests user interface 700 is shown in FIG. 7. As shown in the user interface 700, the advertiser is able to specify a total budget for the campaign and a target gross ratings points (GRPs) goal. In the simplified example shown in FIG. 7, the campaign is directed at seven channels in one market, has a budget of $250,000, and has a target GRP goal of 1250. In other implementations, the advertiser may target one or multiple channels in multiple markets. As noted above, in addition to total budgets and goals, the system 102 may allow advertisers to set budgets and goals on other bases, such as by market, channel, daypart, affiliate, week, spot length, etc. Once the advertiser submits the requests, messages may be sent to each of a plurality of sellers that are customized based on the configuration of the campaign specified in the user interface 600.

At 306, the automated advertisement purchase system 102 may receive a plurality of offers for advertisement placement opportunities from a plurality of mediacast content providers. In some instances, the advertiser may negotiate back and forth one or more times with one or more mediacast content providers until terms (e.g., price, gross rating points (GRPs) guarantee) are agreeable to both sides.

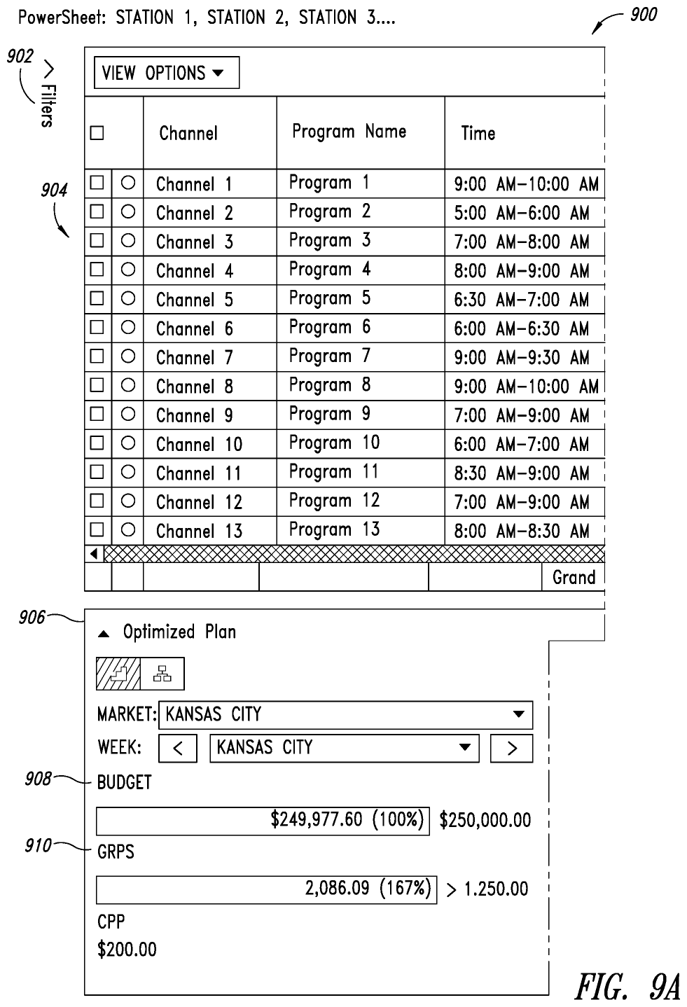

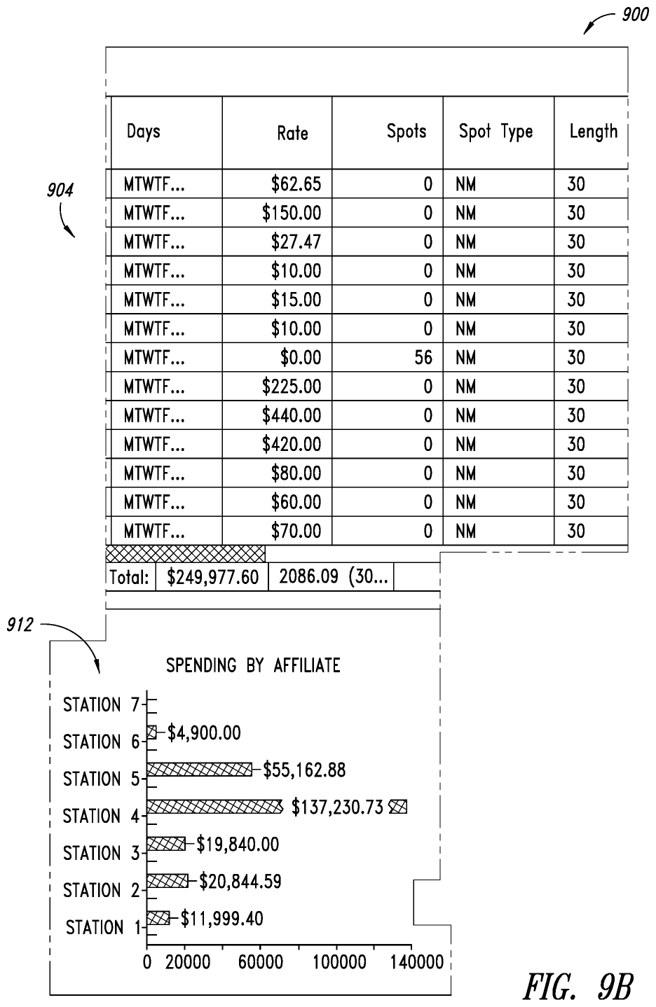

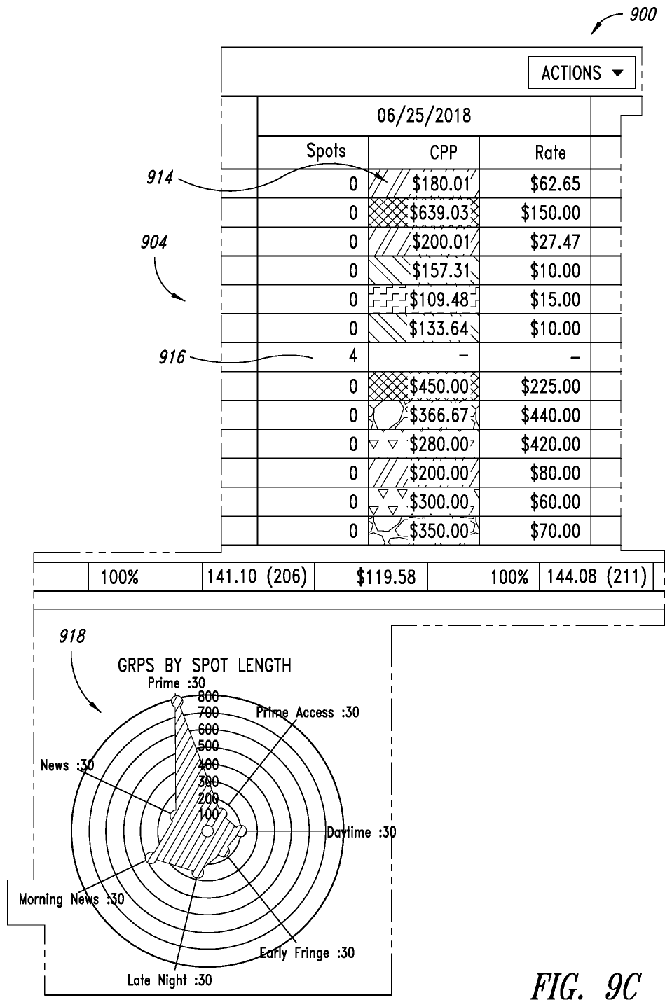

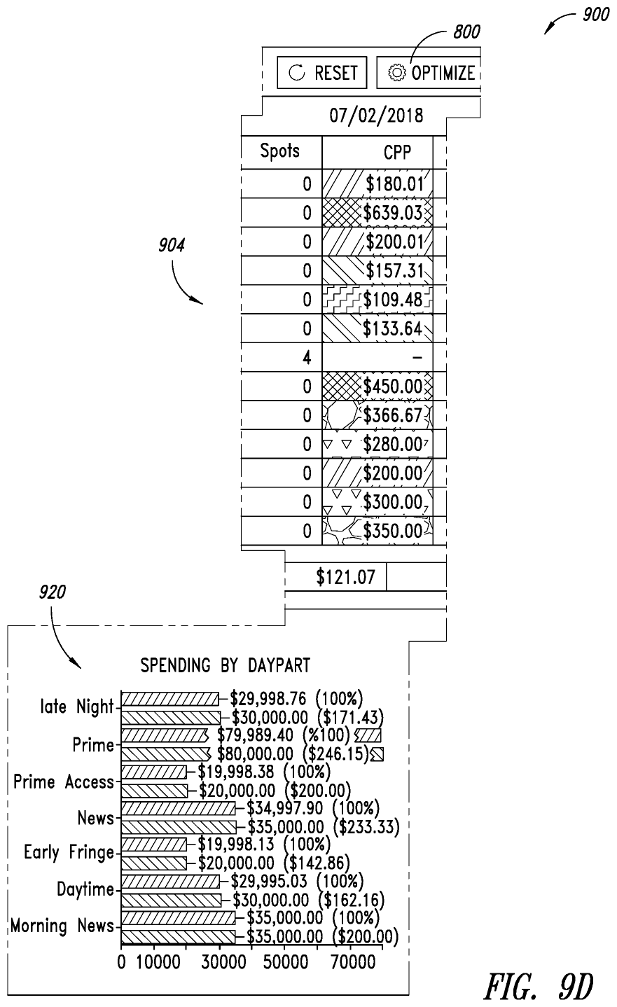

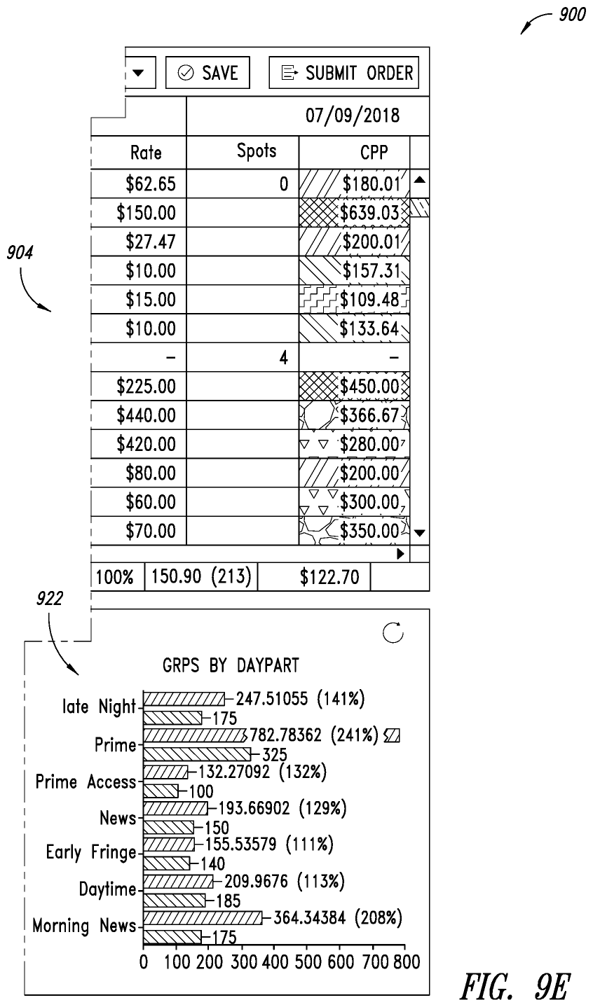

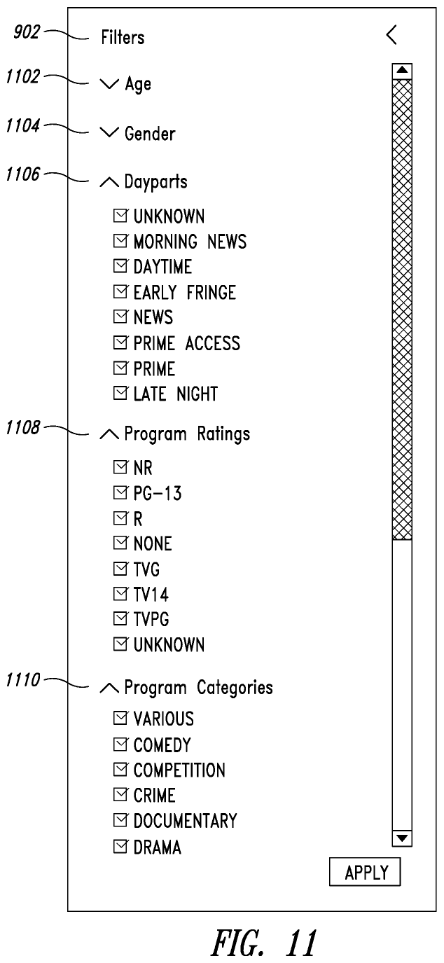

Once the automated advertisement purchase system 102 has received the offers from the plurality of mediacast content providers, the automated advertisement purchase system may present the offers in tabular form in a “PowerSheet” or dashboard. An example dashboard 900 is shown in FIGS. 9A-9E. The dashboard 900 may include a number of windows or portions, such as a filters window 902 (see also FIG. 11), a table 904, an optimized plan window 906, a spending by affiliate window 912, a GRPs by spot length window 918, a spending by daypart window 920, and a GRPs by daypart window 922. The table 904 may list the received offers from the various channels, and may include information such as channel, program name, time, days, rate, total spots to purchase, spot type, and length (seconds). Also, as shown in FIGS. 9C-9E, for each week of the campaign, the table 904 may show spots to purchase (e.g., box 916 in FIG. 9D shows 4 spots are to be purchased), cost per rating point (CPP), and rate. As discussed below, the spots to purchase columns may be updated automatically after the campaign optimizer is run.

As indicated by the different hatching 914 (FIG. 9C), the entries in the CPP column (and/or other columns) may be color coded to provide a “heat map.” For example, lower CPP spots may be color coded with the color green, medium CPP spots may be color coded with the color yellow, and high CPP spots may be color coded with the color red. In at least some implementations, numerous shades (e.g., three shades, six shades, 10 shades) of colors may be used to provide a visual representation of the value of each of the offered spots. Thus, the user may quickly identify which spots to select based on the colors in addition to the values (e.g., CPP, rate) presented in the table 904.

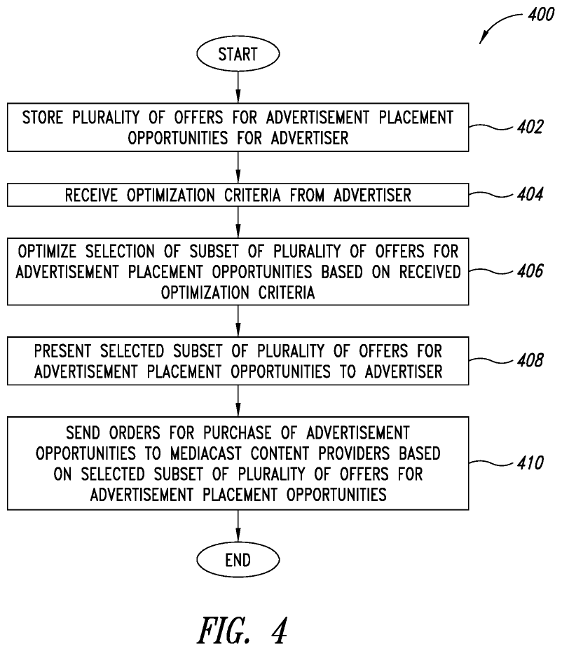

FIG. 4 shows a method 400 of optimizing advertisement placement in linear mediacasts according to one non-limiting illustrated implementation. As discussed above, at 402, the automated advertisement purchase system may store a plurality of offers for advertisement placement opportunities for an advertiser. For example, the plurality of offers may be stored after the automated advertisement purchase system has executed the method 300 discussed above. Each of the plurality of offers for advertisement placement opportunities may include an offer for the advertiser to place one or more advertisements in at least one of a number of linear mediacasts for each of a plurality of mediacast content providers that transmit the linear mediacasts to a plurality of media consumers over a period of time.

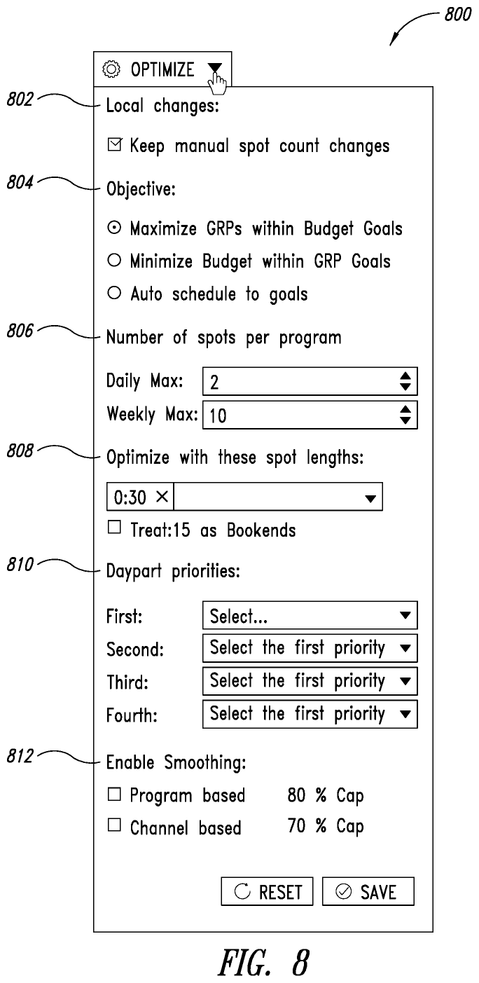

At 404, the automated advertisement purchase system may receive optimization criteria from the advertiser. For example, the automated advertisement purchase system may provide a drop-down optimization window 800 shown in FIG. 8 on the dashboard 900. In at least some implementations, the optimization window 800 allows for configuration of various optimization criteria, such as local changes 802, objective 804, number of spots per program 806, spot lengths 808, daypart priorities 810, and smoothing criteria 812.

The local changes criteria 802 indicates whether the campaign optimizer (e.g., campaign optimizer 105 of FIG. 1) should retain any spot changes that were manually made by the user so that such changes are not affected by running the campaign optimizer.

In the illustrated example, the objective criteria 804 provides three options for the objective of the optimizer: maximize GRPs, or more generally advertising impact, within the budget goals for the campaign, minimize budget within the advertising impact (or GRP) goals, or automatically schedule to meeting both the budget goal and the advertising impact goal. In other implementations, the objective criteria 804 may include fewer or more criteria.

The number of spots per program criteria 806 allows the user to instruct the campaign optimizer to select a maximum number of spots per program on a daily and weekly basis. In the illustrated example, the user has selected a daily maximum of 2 spots per program and a weekly maximum of 10 spots per program.

The optimize with these spot lengths criteria 808 allows the user to specify which spot lengths (e.g., 15 seconds, 30 seconds) should be included in the optimization. In the illustrated example, the user has selected only 30 second spot lengths to be included in the optimization. The optimization window 800 may also include an option to treat 15 second advertisements as “bookends,” which requires each pair of 15 second spots to be placed at the beginning and end of an advertisement break.

The daypart priorities criteria 810 may allow a user to instruct the campaign optimizer to prioritize one or more dayparts (e.g., morning, prime, late night) during the optimization process.

The enable smoothing criteria feature 812 allows the user to specify whether the automated advertisement purchase system should place an upper limit or “cap” on the percentage of the overall budget to be spent on any one program or any one channel during the optimization process. In the example shown, the user has selected an 80% program-based cap and a 70% channel-based cap. Such smoothing advantageously causes the automated advertisement purchase system to suppress areas where the campaign optimizer may otherwise get greedy and select many slots on one channel or program. As an example, if numerous spots for a particular program or channel are desirable (e.g., very low cost) in view of the other specified optimization criteria, without smoothing the automated advertisement purchase system may spend a majority or an entire budget on a single program or channel, which may be an undesirable result for the advertiser who may want advertisements spread across multiple programs and channels.

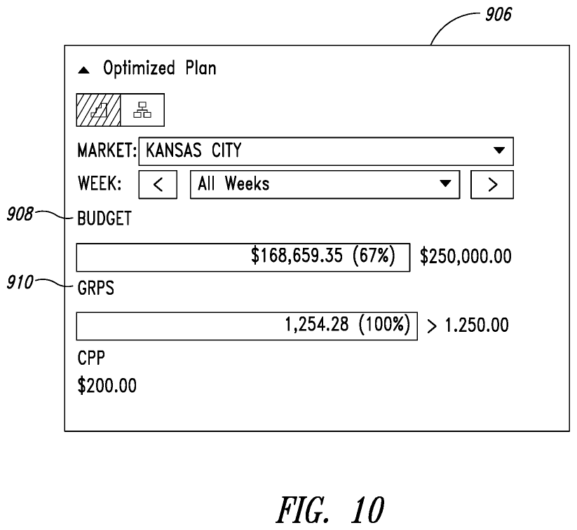

At 406, once the user has set the optimization criteria, the automated advertisement purchase system may optimize a selection of a subset of the plurality of offers for advertisement placement opportunities based at least in part on the received optimization criteria. For example, as shown in the optimized plan window 906 of FIG. 9A, the campaign optimizer has maximized GRPs within the budge goal to provide 2086.09 GRPs while spending $249,977.60 of the $250,000.00 budget, resulting in advertisements that achieve 167% of the GRP goal. As another example, as shown in the optimized plan window 906 of FIG. 10, the campaign optimizer has minimized the budget within the GRP goal to provide 1254.28 GRPs while spending only $168,659.35 of the $250,000.00 budget.

At 408, the automated advertisement purchase system may present the selected subset of the plurality of offers for advertisement placement opportunities to the advertiser via an advertiser-facing user interface, such as the dashboard 900 of FIG. 9.

At 410, the automated advertisement purchase system may send orders for the purchase of advertisement opportunities to the mediacast content providers based on the selected subset of the plurality of offers for advertisement placement opportunities. As noted above, in some implementations, the orders may be placed and the spots may be automatically placed into a traffic system of one or more of the media content providers.

As an example, the automated advertisement purchase system may receive a spending budget from the advertiser. The optimization criteria may include an indication that the advertiser requests to maximize advertising impact (e.g., GRPs), and the campaign optimizer may optimize a selection of a subset of the plurality of offers by determining a subset of the offers to select that maximizes the advertising impact (e.g., GRPs) without exceeding the received spending budget.

As another example, the automated advertisement purchase system may receive an advertising impact target (e.g., target GRPs) and optionally a spending budget from the advertiser. The optimization criteria may include an indication that the advertiser requests to minimize the spending budget. In such instances, the campaign optimizer may optimize a selection of a subset of the plurality of offers by determining a subset of the offers to select that minimizes the spend while meeting the advertising impact target.

As another example, the automated advertisement purchase system may receive a GRPs target (or other advertising impact target) and a spending budget from the advertiser. The optimization criteria may include an indication that the advertiser requests to optimize the selection of offers with respect to both the GRPs target and the spending budget. In such instances, the automated advertisement purchase system may optimizes a selection of a subset of the plurality of offers by determining a subset of the offers that meet both the spending budget and the GRPs target.

As noted above, in at least some implementations, the automated advertisement purchase system may optimize a selection of a subset of the plurality of offers while taking into account one or more advertiser goals or criteria relating to one or more of: target demographics goals, daypart goals, affiliate goals, market level goals, spot length goals, weekly goals, or excluded programs. Further, the automated advertisement purchase system take into account one or more advertiser priorities relating to a spot length priority or a daypart priority.

As discussed above, in at least some implementations, the optimization criteria includes repetition criteria relating to at least one of a maximum number of advertisement opportunities to be selected for a single transmission of any one program or a maximum number of advertisement opportunities to be selected during a multi-day time period (e.g., week, month) for any one program. The repetition criteria may be received from the advertiser or a media content provider that is offering one or more of the advertisement opportunities.

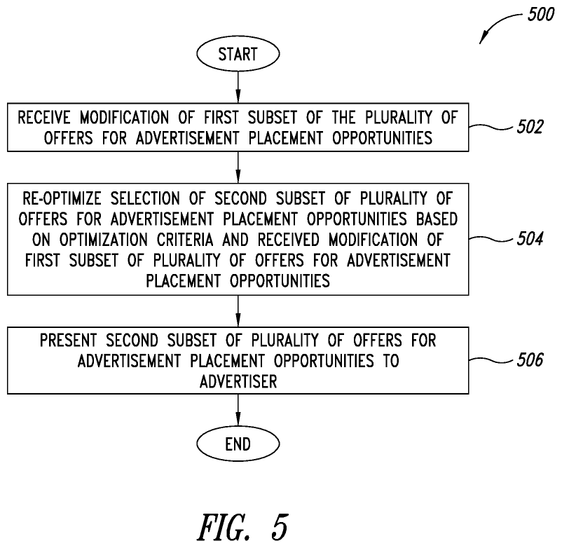

FIG. 5 shows a method 500 of operating an automated advertisement purchase system to re-optimize a selection of a plurality of offers to purchase, according to one or more implementations of the present disclosure. The method 500 may performed subsequent to at least one iteration of the method 400 discussed above, for example. Further, in at least some implementations, the method 500 may only be performed when the “keep manual spot count changes” box 802 is selected (see FIG. 8 and discussion above).

At 502, the automated advertisement purchase system may receive, via the advertiser-facing user interface, a modification of the first subset (previously optimized subset) of the plurality of offers for advertisement placement opportunities. For example, referring to FIG. 9C, the user may manually change the cell 916 from 4 spots to a different number (e.g., 3 spots, 0 spots) of spots. The user may make any number of manual changes to the previously optimized spots.

At 504, the automated advertisement purchase system re-optimizes a selection of a second subset of the plurality of offers for advertisement placement opportunities based at least in part on the received optimization criteria and the received modification of the first subset of the plurality of offers for advertisement placement opportunities. For example, the automated advertisement purchase system may retain the manually changed spots and optimize the other offers without modifying the manually changed spots.

At 506, the automated advertisement purchase system presents the second subset of the plurality of offers for advertisement placement opportunities to the advertiser via an advertiser-facing user interface.

The modification of the first subset of the plurality of offers may include at least one of manual selection of an offer that is not in the first subset of the plurality of offers (e.g., changing a cell from 0 spots to 2 spots, changing a cell from 1 spot to 3 spots), or manual de-selection of an offer that is in the first subset of the plurality of offers (e.g., changing a cell from 3 spots to 0 spots, changing a cell from 4 spots to 2 spots).

In at least some implementations, the automated advertisement purchase system may allow the user to modify which spots to include based on filtering criteria that excludes one or more of the plurality of offers from consideration. FIG. 11 shows a non-limiting example of various filtering criteria 902, which may include age 1102, gender 1104, dayparts 1106, program ratings 1108, or program categories 1110. It should be appreciated that in on other implementations, fewer or more filtering criteria may be used to determine which offers are considered by the campaign optimizer.

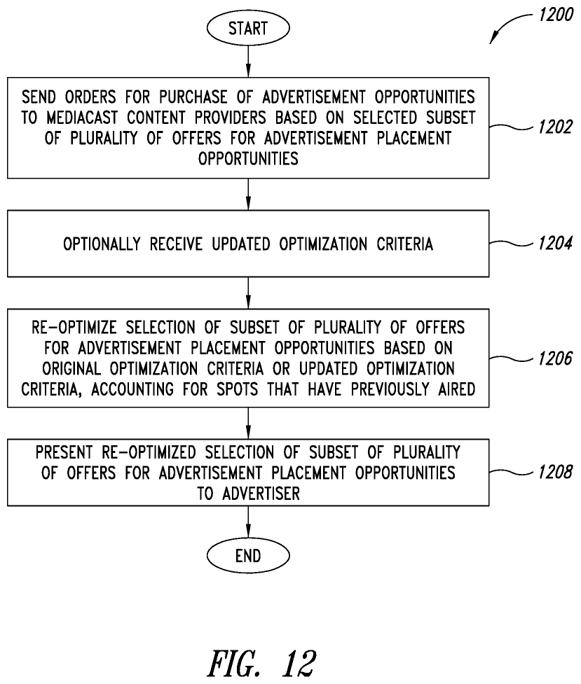

FIG. 12 shows a method 1200 of operating an automated advertisement purchase system to re-optimize a selection of a plurality of offers to purchase after orders have been placed (e.g., during the campaign), according to one or more implementations of the present disclosure. The method 1200 may be performed subsequent to at least one iteration of the method 400 discussed above, for example. Further, in at least some implementations, the method 1200 may only be performed when the “keep manual spot count changes” box 802 is selected (see FIG. 8 and discussion above).

At 1202, the automated advertisement purchase system may send orders for the purchase of advertisement opportunities to the mediacast content providers based on the selected subset of the plurality of offers for advertisement placement opportunities. As noted above, in some implementations, the orders may be placed and the spots may be automatically placed into a traffic system of one or more of the media content providers.

As noted above, in at least some implementations, the automated advertisement purchase system may optimize a selection of a subset of the plurality of offers while taking into account one or more advertiser goals or criteria relating to one or more of: target demographics goals, daypart goals, affiliate goals, market level goals, spot length goals, weekly goals, or excluded programs. Further, the automated advertisement purchase system take into account one or more advertiser priorities relating to a spot length priority or a daypart priority.

At 1204, after the orders have been placed and potentially at least some of the spots have aired, the automated advertisement purchase system may optionally receive, via the advertiser-facing user interface, an update to or modification of the optimization criteria. For example, after the first month of a three month campaign, a user may select new optimization criteria. As another example, the user may retain the same optimization criteria that was initially specified prior to the beginning of the campaign.

At 1206, the automated advertisement purchase system re-optimizes a selection of a second subset of the plurality of offers for advertisement placement opportunities based at least in part on the original optimization criteria or the updated optimization criteria, and accounts for spots that have already aired. For example, the automated advertisement purchase system may re-optimize the selection based on actual or estimated data regarding the amount of budget already spent and the actual or estimated advertising impact (e.g., GRPs) of the spots that have already aired. Thus, the automated advertisement purchase system may consider the remainder of the budget, the remainder of the GRP goal, or other criteria to re-optimize the selection of advertisement placement opportunities for the remainder of the campaign. More generally, the automated advertisement purchase system may take into account information relating to at least one of the respective prices of at least some of the sent orders, the performance of at least some of the sent orders, targeting criteria for at least some of the sent orders, or other information relating to previously sent orders. Thus, if for any reason the current performance of the campaign is not optimal or has not performed as expected, the automated advertisement purchase system can re-optimize the selection at one or more times during the campaign to attempt to meet the advertiser's goals, whether the goals stay the same or are changed during the campaign.

At 1208, the automated advertisement purchase system presents the re-optimized selection of a subset of the plurality of offers for advertisement placement opportunities to the advertiser via an advertiser-facing user interface, as discussed above. The advertiser may then place the orders without modification, or make any manual modifications as desired and then place the orders for the remainder of the campaign.

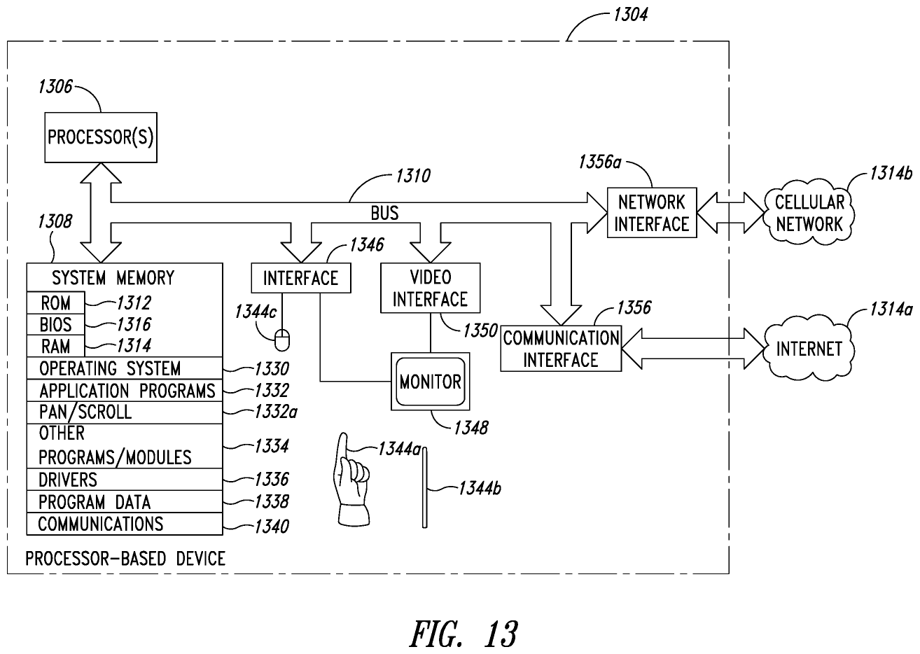

FIG. 13 shows a processor-based device 1304 suitable for implementing the various functionality described herein. Although not required, some portion of the implementations will be described in the general context of processor-executable instructions or logic, such as program application modules, objects, or macros being executed by one or more processors. Those skilled in the relevant art will appreciate that the described implementations, as well as other implementations, can be practiced with various processor-based system configurations, including handheld devices, such as smartphones and tablet computers, wearable devices, multiprocessor systems, microprocessor-based or programmable consumer electronics, personal computers (“PCs”), network PCs, minicomputers, mainframe computers, and the like.

The processor-based device 1304 may include one or more processors 1306, a system memory 1308 and a system bus 1310 that couples various system components including the system memory 1308 to the processor(s) 1306. The processor-based device 1304 will at times be referred to in the singular herein, but this is not intended to limit the implementations to a single system, since in certain implementations, there will be more than one system or other networked computing device involved. Non-limiting examples of commercially available systems include, but are not limited to, ARM processors from a variety of manufactures, Core microprocessors from Intel Corporation, U.S.A., PowerPC microprocessor from IBM, Sparc microprocessors from Sun Microsystems, Inc., PA-RISC series microprocessors from Hewlett-Packard Company, 68xxx series microprocessors from Motorola Corporation.

The processor(s) 1306 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 13 are of conventional design. As a result, such blocks need not be described in further detail herein, as they will be understood by those skilled in the relevant art.

The system bus 1310 can employ any known bus structures or architectures, including a memory bus with memory controller, a peripheral bus, and a local bus. The system memory 1308 includes read-only memory (“ROM”) 1312 and random access memory (“RAM”) 1314. A basic input/output system (“BIOS”) 1316, which can form part of the ROM 1312, contains basic routines that help transfer information between elements within processor-based device 1304, such as during start-up. Some implementations may employ separate buses for data, instructions and power.

The processor-based device 1304 may also include one or more solid state memories, for instance Flash memory or solid state drive (SSD) 1318, which provides nonvolatile storage of computer-readable instructions, data structures, program modules and other data for the processor-based device 1304. Although not depicted, the processor-based device 1304 can employ other nontransitory computer- or processor-readable media, for example a hard disk drive, an optical disk drive, or memory card media drive.

Program modules can be stored in the system memory 1308, such as an operating system 1330, one or more application programs 1332, other programs or modules 1334, drivers 1336 and program data 1338.

The application programs 1332 may, for example, include panning/scrolling 1332a. Such panning/scrolling logic may include, but is not limited to logic that determines when and/or where a pointer (e.g., finger, stylus, cursor) enters a user interface element that includes a region having a central portion and at least one margin. Such panning/scrolling logic may include, but is not limited to logic that determines a direction and a rate at which at least one element of the user interface element should appear to move, and causes updating of a display to cause the at least one element to appear to move in the determined direction at the determined rate. The panning/scrolling logic 1332a may, for example, be stored as one or more executable instructions. The panning/scrolling logic 1332a may include processor and/or machine executable logic or instructions to generate user interface objects using data that characterizes movement of a pointer, for example data from a touch-sensitive display or from a computer mouse or trackball, or other user interface device.

The system memory 1308 may also include communications programs 1340, for example a server and/or a Web client or browser for permitting the processor-based device 1304 to access and exchange data with other systems such as user computing systems, Web sites on the Internet, corporate intranets, or other networks as described below. The communications programs 1340 in the depicted implementation is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 13 as being stored in the system memory 1308, the operating system 1330, application programs 1332, other programs/modules 1334, drivers 1336, program data 1338 and server and/or browser 1340 can be stored on any other of a large variety of nontransitory processor-readable media (e.g., hard disk drive, optical disk drive, SSD and/or flash memory).

A user can enter commands and information via a pointer, for example through input devices such as a touch screen 1348 via a finger 1344a, stylus 1344b, or via a computer mouse or trackball 1344c which controls a cursor. Other input devices can include a microphone, joystick, game pad, tablet, scanner, biometric scanning device, etc. These and other input devices (i.e., “I/O devices”) are connected to the processor(s) 1306 through an interface 1346 such as touch-screen controller and/or a universal serial bus (“USB”) interface that couples user input to the system bus 1310, although other interfaces such as a parallel port, a game port or a wireless interface or a serial port may be used. The touch screen 1348 can be coupled to the system bus 1310 via a video interface 1350, such as a video adapter to receive image data or image information for display via the touch screen 1348. Although not shown, the processor-based device 1304 can include other output devices, such as speakers, vibrator, haptic actuator, etc.

The processor-based device 1304 may operate in a networked environment using one or more of the logical connections to communicate with one or more remote computers, servers and/or devices via one or more communications channels, for example, one or more networks 1314a, 1314b. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, the processor-based device 1304 may include one or more wired or wireless communications interfaces 1314a, 1314b (e.g., cellular radios, WI-FI radios, Bluetooth radios) for establishing communications over the network, for instance the Internet 1314a or cellular network.

In a networked environment, program modules, application programs, or data, or portions thereof, can be stored in a server computing system (not shown). Those skilled in the relevant art will recognize that the network connections shown in FIG. 13 are only some examples of ways of establishing communications between computers, and other connections may be used, including wirelessly.

For convenience, the processor(s) 1306, system memory 1308, network and communications interfaces 1314a, 1314b are illustrated as communicably coupled to each other via the system bus 1310, thereby providing connectivity between the above-described components. In alternative implementations of the processor-based device 1304, the above-described components may be communicably coupled in a different manner than illustrated in FIG. 13. For example, one or more of the above-described components may be directly coupled to other components, or may be coupled to each other, via intermediary components (not shown). In some implementations, system bus 1310 is omitted and the components are coupled directly to each other using suitable connections.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various implementations described above can be combined to provide further implementations. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method of optimizing advertisement placement in linear mediacasts, the method comprising:
storing, in at least one nontransitory processor-readable storage medium, a plurality of offers for advertisement placement opportunities for an advertiser, each of the plurality of offers for advertisement placement opportunities comprising an offer for the advertiser to place one or more advertisements in at least one of a number of linear mediacasts for each of a plurality of mediacast content providers that transmit the linear mediacasts to a plurality of media consumers over a period of time;
receiving, by at least one processor, optimization criteria from the advertiser;
optimizing, by the at least one processor, a selection of a subset of the plurality of offers for advertisement placement opportunities based at least in part on the received optimization criteria; and
presenting, by the at least one processor, the selected subset of the plurality of offers for advertisement placement opportunities to the advertiser via an advertiser-facing user interface.

2. The method of claim 1, further comprising:
sending, by the at least one processor, orders for the purchase of advertisement opportunities to the mediacast content providers based on the selected subset of the plurality of offers for advertisement placement opportunities.

3. The method of claim 2, further comprising:
subsequent to the sending of the orders, re-optimizing a selection of a plurality of offers for advertisement placement opportunities based on optimization criteria and based on information relating to the sent orders.

4. The method of claim 3, further comprising:
prior to re-optimizing, receiving, by the at least one processor, updated optimization criteria from the advertiser.

5. The method of claim 3 wherein the information regarding the sent orders comprises information relating to at least one of the respective prices of at least some of the sent orders, the performance of at least some of the sent orders, or targeting criteria for at least some of the sent orders.

6. The method of claim 1, further comprising:
receiving, by the at least one processor, a spending budget from the advertiser, wherein receiving the optimization criteria comprises receiving an indication that the advertiser requests to maximize advertising impact, and optimizing a selection of a subset of the plurality of offers comprises determining a subset of the offers to select that maximizes the advertising impact without exceeding the received spending budget.

7. The method of claim 1, further comprising:
receiving, by the at least one processor, an advertising impact target and a spending budget from the advertiser, wherein receiving the optimization criteria comprises receiving an indication that the advertiser requests to minimize the spending budget, and optimizing a selection of a subset of the plurality of offers comprises determining a subset of the offers to select that minimizes the spend while meeting the advertising impact target.

8. The method of claim 1, further comprising:
receiving, by the at least one processor, a spending budget from the advertiser, wherein receiving the optimization criteria comprises receiving an indication that the advertiser requests to maximize gross ratings points (GRPs), and optimizing a selection of a subset of the plurality of offers comprises determining a subset of the offers to select that maximizes the GRPs without exceeding the received spending budget.

9. The method of claim 1, further comprising:
receiving, by the at least one processor, a gross ratings points (GRPs) target and a spending budget from the advertiser, wherein receiving the optimization criteria comprises receiving an indication that the advertiser requests to minimize the spending budget, and optimizing a selection of a subset of the plurality of offers comprises determining a subset of the offers to select that minimizes the spending amount while meeting the GRPs target.

10. The method of claim 1 wherein the selected subset of the plurality of offers comprises a first subset, the method further comprising:
receiving, by the at least one processor via the advertiser-facing user interface, a modification of the first subset of the plurality of offers for advertisement placement opportunities;
re-optimizing, by the at least one processor, a selection of a second subset of the plurality of offers for advertisement placement opportunities based at least in part on the received optimization criteria and the received modification of the first subset of the plurality of offers for advertisement placement opportunities; and
presenting, by the at least one processor, the second subset of the plurality of offers for advertisement placement opportunities to the advertiser via an advertiser-facing user interface.

11. The method of claim 10 wherein receiving a modification of the first subset of the plurality of offers comprises at least one of: manual selection of an offer that is not in the first subset of the plurality of offers, or manual de-selection of an offer that is in the first subset of the plurality of offers.

12. The method of claim 10 wherein receiving a modification of the first subset of the plurality of offers comprises receiving filtering criteria that excludes one or more of the plurality of offers from consideration.

13. The method of claim 12 wherein receiving filtering criteria comprises receiving filtering criteria that relates to at least one of: programming content category, programming content rating, programming content daypart, or programming content target demographics.

14. The method of claim 1 wherein the optimization criteria includes repetition criteria relating to at least one of:
a maximum number of advertisement opportunities to be selected for a single transmission of any one program; or
a maximum number of advertisement opportunities to be selected during a multi-day time period for any one program.

15. The method of claim 14, further comprising:
receiving, by the at least one processor, the repetition criteria from the advertiser.

16. The method of claim 14, further comprising:
receiving, by the at least one processor, the repetition criteria from a media content provider that is offering one or more of the advertisement opportunities.

17. The method of claim 1 wherein the optimization criteria includes smoothing criteria that specifies at least one of:
a maximum percentage of a specified budget that is allowed to be spent for any one program; or
a maximum percentage of a specified budget that is allowed to be spent for any one channel.

18. The method of claim 1, further comprising:
receiving, by the at least one processor, a gross ratings points (GRPs) target and a spending budget from the advertiser, wherein receiving the optimization criteria comprises receiving an indication that the advertiser requests to optimize the selection of offers with respect to both the GRPs target and the spending budget, and optimizing a selection of a subset of the plurality of offers comprises determining a subset of the offers that meet both the spending budget and the GRPs target.

19. The method of claim 1 wherein optimizing a selection of a subset of the plurality of offers takes into account one or more advertiser goals or criteria relating to one or more of: target demographics goals, daypart goals, affiliate goals, market level goals, spot length goals, weekly goals, or excluded programs.

20. The method of claim 1 wherein optimizing a selection of a subset of the plurality of offers takes into account one or more advertiser priorities relating to a spot length priority or a daypart priority.

21. The method of claim 1 wherein presenting the selected subset of the plurality of offers comprises presenting the selected subset of the plurality of offers for advertisement placement opportunities on a heat map that is color-coded with respect to at least one of cost per point (CPP) or the number of selected offers for a particular program.

22. The method of claim 1, further comprising:
receiving, by the at least one processor, requests for available advertisement placement opportunities from the advertiser;
sending, by the at least one processor, the received requests for available advertisement placement opportunities to the plurality of mediacast content providers; and
receiving, by the at least one processor, the plurality of offers for advertisement placement opportunities from the plurality of mediacast content providers.

23. A system to optimize advertisement placement in linear mediacasts, the system comprising:
at least one nontransitory processor-readable storage medium that stores at least one of instructions or data, and which stores a plurality of offers for advertisement placement opportunities for an advertiser, each of the plurality of offers for advertisement placement opportunities comprising an offer for the advertiser to place one or more advertisements in at least one of a number of linear mediacasts for each of a plurality of mediacast content providers that transmit the linear mediacasts to a plurality of media consumers over a period of time; and
at least one processor communicatively coupled to the at least one nontransitory processor-readable storage medium, in operation, the at least one processor:
receives optimization criteria from the advertiser;
optimizes a selection of a subset of the plurality of offers for advertisement placement opportunities based at least in part on the received optimization criteria; and
presents the selected subset of the plurality of offers for advertisement placement opportunities to the advertiser via an advertiser-facing user interface.

24. The system of claim 23 wherein the at least one processor:
sends orders for the purchase of advertisement opportunities to the mediacast content providers based on the selected subset of the plurality of offers for advertisement placement opportunities.

25. The system of claim 24 wherein the at least one processor:
subsequent to sending of the orders, re-optimizes a selection of a plurality of offers for advertisement placement opportunities based on optimization criteria and based on information relating to the sent orders.

26. The system of claim 25 wherein the at least one processor:
prior to the re-optimization, receives updated optimization criteria from the advertiser.

27. The system of claim 25 wherein the information regarding the sent orders comprises information relating to at least one of the respective prices of at least some of the sent orders, the performance of at least some of the sent orders, or targeting criteria for at least some of the sent orders.

28. The system of claim 23 wherein the at least one processor:
receives a spending budget from the advertiser, wherein the optimization criteria comprises an indication that the advertiser requests to maximize advertising impact, and the at least one processor determines a subset of the offers to select that maximizes the advertising impact without exceeding the received spending budget.

29. The system of claim 23 wherein the at least one processor:
receives an advertising impact target and a spending budget from the advertiser, wherein the optimization criteria comprises an indication that the advertiser requests to minimize the spending budget, and the at least one processor determines a subset of the offers to select that minimizes the spend while meeting the advertising impact target.

30. The system of claim 23 wherein the at least one processor:
receives a spending budget from the advertiser, wherein the optimization criteria comprises an indication that the advertiser requests to maximize gross ratings points (GRPs), and the at least one processor determines a subset of the offers to select that maximizes the GRPs without exceeding the received spending budget.

31. The system of claim 23 wherein the at least one processor:
receives a gross ratings points (GRPs) target and a spending budget from the advertiser, wherein the optimization criteria comprises an indication that the advertiser requests to minimize the spending budget, and the at least one processor determines a subset of the offers to select that minimizes the spending amount while meeting the GRPs target.

32. The system of claim 23 wherein the selected subset of the plurality of offers comprises a first subset, and the at least one processor:
receives, via the advertiser-facing user interface, a modification of the first subset of the plurality of offers for advertisement placement opportunities;
re-optimizes a selection of a second subset of the plurality of offers for advertisement placement opportunities based at least in part on the received optimization criteria and the received modification of the first subset of the plurality of offers for advertisement placement opportunities; and
presents the second subset of the plurality of offers for advertisement placement opportunities to the advertiser via the advertiser-facing user interface.

33. The system of claim 32 wherein the modification of the first subset of the plurality of offers comprises at least one of: manual selection of an offer that is not in the first subset of the plurality of offers, or manual de-selection of an offer that is in the first subset of the plurality of offers.

34. The system of claim 32 wherein the modification of the first subset of the plurality of offers comprises filtering criteria that excludes one or more of the plurality of offers from consideration.

35. The system of claim 34 wherein the filtering criteria relates to at least one of: programming content category, programming content rating, programming content daypart, or programming content target demographics.

36. The system of claim 23 wherein the optimization criteria includes repetition criteria relating to at least one of:
a maximum number of advertisement opportunities to be selected for a single transmission of any one program; or
a maximum number of advertisement opportunities to be selected during a multi-day time period for any one program.

37. The system of claim 36 wherein the at least one processor:
receives the repetition criteria from the advertiser.

38. The system of claim 36 wherein the at least one processor:
receives the repetition criteria from a media content provider that is offering one or more of the advertisement opportunities.

39. The system of claim 23 wherein the optimization criteria includes smoothing criteria that specifies at least one of:
a maximum percentage of a specified budget that is allowed to be spent for any one program; or
a maximum percentage of a specified budget that is allowed to be spent for any one channel.

40. The system of claim 23 wherein the at least one processor:
receives a gross ratings points (GRPs) target and a spending budget from the advertiser, wherein the optimization criteria comprises an indication that the advertiser requests to optimize the selection of offers with respect to both the GRPs target and the spending budget, and the at least one processor determines a subset of the offers that meet both the spending budget and the GRPs target.

41. The system of claim 23 wherein the at least one processor optimizes a selection of a subset of the plurality of offers taking into account one or more advertiser goals or criteria relating to one or more of: target demographics goals, daypart goals, affiliate goals, market level goals, spot length goals, weekly goals, or excluded programs.

42. The system of claim 23 wherein the at least one processor optimizes a selection of a subset of the plurality of offers taking into account one or more advertiser priorities relating to a spot length priority or a daypart priority.

43. The system of claim 23 wherein the at least one processor presents the selected subset of the plurality of offers for advertisement placement opportunities on a heat map that is color-coded with respect to at least one of cost per point (CPP) or the number of selected offers for a particular program.

44. The system of claim 23 wherein the at least one processor:
receives requests for available advertisement placement opportunities from the advertiser;
sends the received requests for available advertisement placement opportunities to the plurality of mediacast content providers; and
receives the plurality of offers for advertisement placement opportunities from the plurality of mediacast content providers.

45. A nontransitory processor-readable storage medium that stores at least one of instructions or data, and which stores a plurality of offers for advertisement placement opportunities for an advertiser, each of the plurality of offers for advertisement placement opportunities comprising an offer for the advertiser to place one or more advertisements in at least one of a number of linear mediacasts for each of a plurality of mediacast content providers that transmit the linear mediacasts to a plurality of media consumers over a period of time, the at least one nontransitory processor-readable storage medium, when executed by at least one processor of an audience delivery optimizer system, cause the at least one processor to:
receive optimization criteria from the advertiser;
optimize a selection of a subset of the plurality of offers for advertisement placement opportunities based at least in part on the received optimization criteria; and
present the selected subset of the plurality of offers for advertisement placement opportunities to the advertiser via an advertiser-facing user interface.
